(19) United States
(12) Patent Application Publication
(10) Pub. No.: US 2009/0159679 A1
(43) Pub. Date: Jun. 25, 2009

(54) Ultra Low-Power User Authentication Device for Financial Transactions

(75) Inventor: Simon Blythe, Cambridgeshire (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/961,281

(22) Filed: Dec. 20, 2007

(51) Int. Cl. G06K 7/08; G06Q 40/00; G06K 7/10

(52) U.S. Cl. 235/449; 705/67; 235/454

(57) ABSTRACT

A low-power device is adapted to authenticate a user desiring to conduct a financial transaction includes an input device, a computing device, and a power source. The input device is adapted to input user information. The computing device is operatively coupled to the input device, adapted to compare the input user information to stored user information, and authenticate the user based on the comparison. The power source provides power to at least the input device. The power source is adapted to obtain power from thermal energy, light energy, and/or electromagnetic energy, which is derived from the user and/or an ambient environment. A method of authenticating a user desiring to conduct a financial transaction includes inputting input user information, comparing the input user information to stored user information, authenticating the user based on the comparison, and performing the inputting using power obtained from thermal energy, light energy, and/or electromagnetic energy.

### BACKGROUND OF THE INVENTION

1. Field of the Invention

The present invention generally relates to conducting financial transactions, and more particularly to an ultra low-power device adapted to authenticate users desiring to conduct a financial transaction.

2. Brief Description of the Related Art

Financial transactions, such as banking functions performed at an automated teller machine (ATM) or point-of-sale transactions using payment cards or radio frequency identification (RFID) payment technology, such as a MasterCard® PayPass™ device, or smartcard are controlled by at least two conflicting requirements. One is that the transaction be completed in the shortest possible time and as conveniently as possible to satisfy the needs of the customer. The other requirement concerns the security of the transaction and includes user authentication or verification. As the security of the transaction is increased the time required to complete the transaction ordinarily increases. Conversely, as the duration of the transaction is reduced, its security may be compromised.

Accordingly, there is a need to both reduce the duration of financial transactions while retaining or increasing the corresponding level of security of such transaction.

### SUMMARY OF THE INVENTION

A low-power device adapted to authenticate a user desiring to conduct a financial transaction formed in accordance with one form of the present invention, which incorporates at least some of the preferred features includes an input device, a computing device, and a power source. The input device is adapted to input user information. The computing device is operatively coupled to the input device, adapted to compare the input user information to stored user information, and adapted to authenticate the user based on the comparison. The power source is adapted to provide power to the input device and to obtain power from thermal energy, light energy, and/or electromagnetic energy. The thermal energy, light energy, and electromagnetic energy is obtained from at least one of the user and an ambient environment.

The power source may also be adapted to provide power to the computing device. The device may also include a secondary storage device operatively coupled to the computing device and adapted to store the stored user information. The power source may provide power to the secondary storage device. The input user information may include biometric information and/or a personal identification number (PIN). The low-power device may be adapted to be incorporated in a smart card and/or an RFID payment device.

A method of authenticating a user desiring to conduct a financial transaction in accordance with one form of the present invention, which incorporates at least some of the preferred features includes inputting input user information, comparing the input user information to stored user information, authenticating the user based on the comparison, and performing the inputting using power obtained from thermal energy, light energy, and/or electromagnetic energy. The thermal energy, light energy, and/or electromagnetic energy is obtained from the user and/or an ambient environment.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of an ultra low-power device that is adapted to authenticate a user during a financial transaction in accordance with the present invention.

FIG. 2 is flowchart of the operation of the device shown in FIG. 1.

### DETAILED DESCRIPTION OF THE PREFERRED EMBODIMENTS

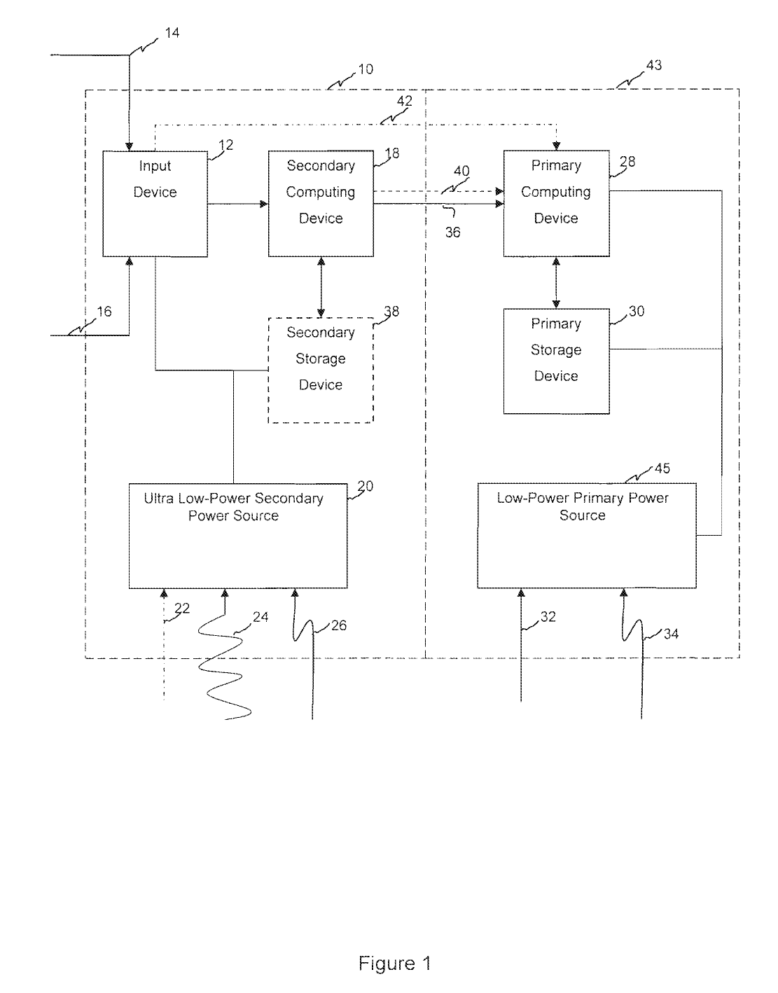

FIG. 1 shows a block diagram of an ultra low-power device 10 adapted to authenticate a user during a financial transaction in accordance with the present invention. The device 10 preferably includes an input device 12, which can include a sensor that preferably receives biometric information 14, such as a fingerprint, and/or a personal identification number (PIN) 16. The device 10 also includes a secondary computing device 18, which is operatively coupled to the input device 12 and receives information from the input device 12. A ultra low-power secondary power source 20 preferably provides power to the input device 12 and computing device 18 from ambient and/or background low-power sources, such as body and/or ambient thermal energy 22, solar and/or ambient light energy 24, and weak and/or ambient electromagnetic or RF field energy 26. For example, body thermal energy could be obtained from heat derived from the user's hand or finger.

The device 10 is preferably coupled to the primary circuitry 43 of a smart card or an RFID payment device, which includes a primary computing device 28, such as a central processing unit (CPU). The primary computing device 28 is operatively coupled to a primary storage device 30. A low-power primary power source 45 preferably provides power to both the primary computing device 28 and storage device 30, which is derived from electrical energy 32 and/or RF field energy 34 provided when the card is in proximity with the financial terminal. The primary circuitry 43 preferably includes the primary computing device 28, low-power primary power source 45, and primary storage device 30. It is to be understood that the various components shown in FIG. 1 may constitute the same or different devices while remaining within the scope of the present invention. For example, the secondary and primary computing devices 18, 28 may be the same device or a different device.

In a first embodiment, the secondary computing device 18 preferably receives user information from the input device 12, which it may reformat in a form suitable to be received by the primary computing device 28 and provides this information as secondary sensor signal 36. The primary computing device 28 then compares the user information received from the computing device 18 with information in a profile for the user authorized to complete the financial transaction, which is preferably stored in the storage device 30 and either proceeds or aborts the financial transaction based on this comparison.

In a second embodiment, the computing device 18 preferably inputs user information from the input device 12 and compares the user information received to the profile information concerning the user authorized to perform the financial transaction, which is preferably stored in a secondary storage device 38. The secondary storage device 38 is operatively coupled to the secondary computing device 18. The secondary storage device 38 is also preferably powered by the ultra low-power secondary power source 20. The computing device 18 then preferably outputs an authentication signal 40 to the primary computing device 28, which indicates whether the user has been authenticated. The primary computing device 28 then proceeds to complete or abort the financial transaction based on the authentication signal 40.

In a third embodiment, the input device 12 preferably provides the user information to the primary computing device 28 as a user information signal 42. The primary computing device 28 then preferably proceeds to complete or abort the financial transaction based on the user information signal 42. It is anticipated that in any of the embodiments of the present invention that information output by the device 10 can be stored by the device 10 until the remaining primary circuitry 43 on the card is powered up or otherwise ready to accept the information.

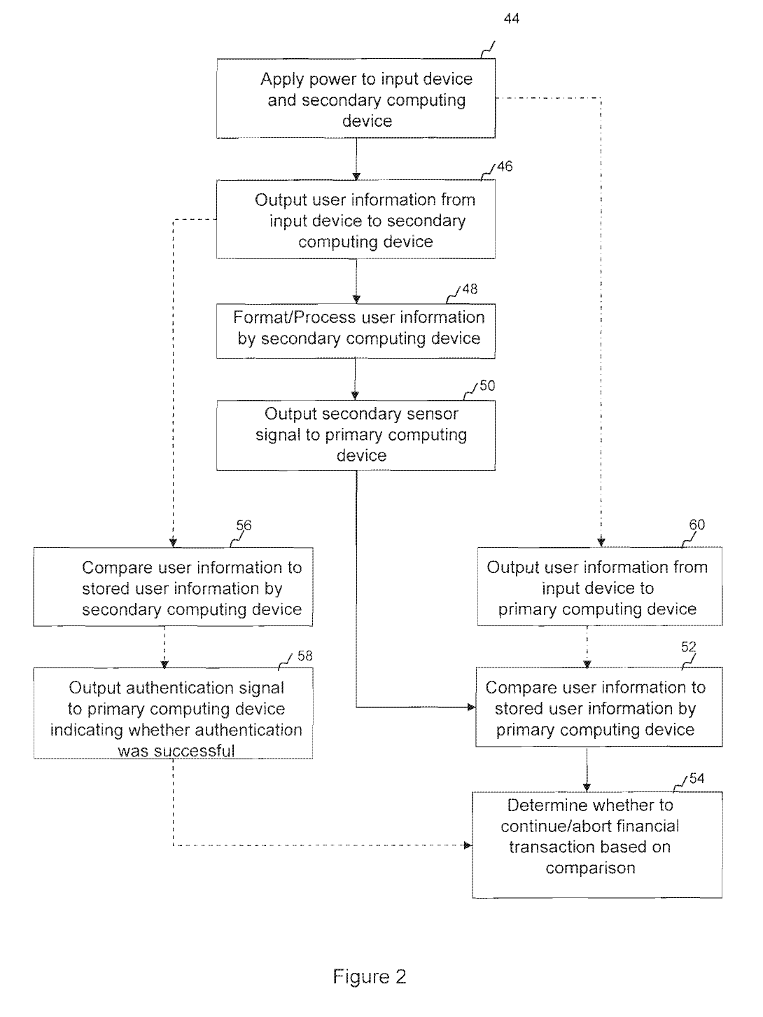

FIG. 2 shows the operation of the three preferred embodiments of the device 10 in conjunction with the remaining circuitry 43 on the card shown in FIG. 1 in accordance with the present invention. Power is applied to the secondary computing device and input device from the ultra low-power secondary power source in step 44. In a first embodiment, the input device then outputs user information to the secondary computing device in step 46. The second computing device may then format or otherwise process the user information received from the input device to a form suitable for the primary computing device in step 48. The secondary computing device then outputs the processed user information as a secondary sensor signal to the primary computing device in step 50. The primary computing device then compares the secondary sensor signal to the authorized user's profile in the primary storage device in step 52. The primary computing device determines whether to continue or abort the financial transaction based on this comparison in step 54.

In the second embodiment, following step 46, the secondary computing device preferably compares the user information received from the input device to the authorized user's profile stored in the secondary storage device in step 56. The secondary computing device then outputs the authentication signal to the primary computing device to indicate whether the authentication was successful in step 58. The primary computing device then determines whether to continue or abort the financial transaction based on the authentication signal in step 54.

In the third embodiment, following step 44, the input device preferably outputs a user information signal to the primary computing device in step 60. The primary computing device then compares the user information signal to the authorized user's profile stored in the primary storage device in step 52. The primary computing device then determines whether to continue or abort the financial transaction based on this comparison in step 54.

The computing devices 18, 40 may be implemented using a microprocessor, digital signal processor, microcontroller, application specific integrated circuit (ASIC), gate array, programmable logic, and/or alternative means well known in the art. The storage devices 38, 30 may be implemented using static random access memory (SRAM), read only memory (ROM), non-volatile RAM, Flash memory, dynamic RAM (DRAM, and/or alternative means well known in the art.

Thus, the device formed in accordance with the present invention effectively shortens the overall time required to complete a financial transaction by performing authorization functions using, for example, biometric information or a PIN, as the user is approaching the financial terminal and/or before the user comes into contact with or enters the RF field associated with the financial terminal.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A low-power device adapted to authenticate a user desiring to conduct a financial transaction comprising:
an input device adapted to input user information;
a computing device operatively coupled to the input device, the computing device being adapted to compare the input user information to stored user information, the computing device being adapted to authenticate the user based on the comparison; and
a power source capable of providing power to the input device, the power source being adapted to obtain power from at least one of thermal energy, light energy, and electromagnetic energy, the at least one of thermal energy, light energy, and electromagnetic energy being obtained from at least one of the user and an ambient environment.

2. A low-power device adapted to authenticate a user desiring to conduct a financial transaction defined by claim 1, wherein the power source is capable of capable of providing power to the computing device.

3. A low-power device adapted to authenticate a user desiring to conduct a financial transaction defined by claim 1, further comprising a secondary storage device operatively coupled to the computing device, the secondary storage device being capable of storing the stored user information, the power source providing power to the secondary storage device.

4. A low-power device adapted to authenticate a user desiring to conduct a financial transaction defined by claim 1, wherein the input user information comprises at least one of biometric information and a personal identification number (PIN).

5. A low-power device adapted to authenticate a user desiring to conduct a financial transaction defined by claim 1, wherein the low-power device is capable of being incorporated in at least one of a smart card and a radio frequency identification payment device.

6. A method of authenticating a user desiring to conduct a financial transaction comprising:
obtaining input user information using power obtained from at least one of thermal energy, light energy, and electromagnetic energy, the at least one of thermal energy, light energy and electromagnetic energy being obtained from at least one of the user and an ambient environment;
comparing the input user information to stored user information; and
authenticating the user based on the comparison.

7. A method of authenticating a user desiring to conduct a financial transaction defined by claim 6, wherein the input user information comprises at least one of biometric information and a personal identification number (PIN).

8. A method of authenticating a user desiring to conduct a financial transaction defined by claim 6, further comprising performing comparing, authenticating, and obtaining in at least one of a smart card and a radio frequency identification payment device.

9. A method of authenticating a user desiring to conduct a financial transaction defined by claim 6, further comprising performing at least one of the comparing and authenticating using power obtained from the at least one of thermal energy, light energy, and electromagnetic energy.

10. A computer-readable medium comprising instructions, wherein execution of the instructions by at least one computing device authenticates a user desiring to conduct a financial transaction by:
obtaining input user information using power obtained from at least one of thermal energy, light energy, and electromagnetic energy, the at least one of thermal energy, light energy and electromagnetic energy being obtained from at least one of the user and an ambient environment;
comparing the input user information to stored user information; and
authenticating the user based on the comparison.

11. A computer-readable medium comprising instructions defined by claim 10, wherein execution of the instructions by at least one computing device authenticates a user desiring to conduct a financial transaction by obtaining the input user information comprising at least one of biometric information and a personal identification number (PIN).

12. A computer-readable medium comprising instructions defined by claim 10, wherein execution of the instructions by at least one computing device authenticates a user desiring to conduct a financial transaction by performing the comparing, authenticating, and obtaining in at least one of a smart card and a radio frequency identification payment device.

13. A computer-readable medium comprising instructions defined by claim 10, wherein execution of the instructions by at least one computing device authenticates a user desiring to conduct a financial transaction by performing at least one of the comparing and authenticating using power obtained from the at least one of thermal energy, light energy, and electromagnetic energy.
